(19) United States
(12) Patent Application Publication
(10) Pub. No.: US 2026/0037346 A1
(43) Pub. Date: Feb. 5, 2026

(54) PROACTIVE MESSAGE CONVERSION

(71) Applicant: INTERNATIONAL BUSINESS MACHINES CORPORATION, ARMONK, NY (US)

(72) Inventors: Simon Francis Page, Southampton (GB); James Oliver Hurst, Eastleigh (GB); Oliver Witham, Kingsclere (GB); Douglas Eric Burns, Didcot (GB)

(21) Appl. No.: 18/788,952

(22) Filed: Jul. 30, 2024

(51) Int. Cl. G06F 9/54

(52) U.S. Cl. CPC G06F 9/546

(57) ABSTRACT

Provided are techniques for proactive message conversion. One or more messages in a first format are stored in a message queue. It is determined that the one or more messages in the message queue are to be converted from the first format to a second format based on a format usage pattern of a consuming application. The one or more of the messages are proactively converted from the first format to the second format. The proactively converted one or more messages in the second format are stored in a converted messages storage. A request is received, from the consuming application, for a message of the one or more messages, where the request indicates that the message is to be in the second format. The message in the second format is returned from the converted messages storage to the consuming application.

### BACKGROUND

Embodiments of the invention relate to proactive message conversion by a message manager.

In a messaging environment where throughput is a criteria of success, a frequent cause of time delay for message consumers is due to the conversion of a message between different formats. For example, when a message source running on a first format server passes messages to a consuming application running on a second format server, the conversion is performed each time a message is consumed so that the message is in the format expected by the consuming application. However, message conversion may be a time consuming operation and may slow down the performance of the consuming application.

### SUMMARY

In accordance with certain embodiments, a computer program product comprising a computer readable storage medium having program code embodied therewith is provided, where the program code is executable by at least one computer processor to perform operations for proactive message conversion. In such embodiments, one or more messages in a first format are stored in a message queue. It is determined that the one or more messages in the message queue are to be converted from the first format to a second format based on a format usage pattern of a consuming application. The one or more of the messages are proactively converted from the first format to the second format. The proactively converted one or more messages in the second format are stored in a converted messages storage. A request is received, from the consuming application, for a message of the one or more messages, where the request indicates that the message is to be in the second format. The message in the second format is returned from the converted messages storage to the consuming application.

In accordance with other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for proactive message conversion. In such embodiments, one or more messages in a first format are stored in a message queue. It is determined that the one or more messages in the message queue are to be converted from the first format to a second format based on a format usage pattern of a consuming application. The one or more of the messages are proactively converted from the first format to the second format. The proactively converted one or more messages in the second format are stored in a converted messages storage. A request is received, from the consuming application, for a message of the one or more messages, where the request indicates that the message is to be in the second format. The message in the second format is returned from the converted messages storage to the consuming application.

In accordance with yet other embodiments, a computer-implemented method comprising operations is provided for proactive message conversion. In such embodiments, one or more messages in a first format are stored in a message queue. It is determined that the one or more messages in the message queue are to be converted from the first format to a second format based on a format usage pattern of a consuming application. The one or more of the messages are proactively converted from the first format to the second format. The proactively converted one or more messages in the second format are stored in a converted messages storage. A request is received, from the consuming application, for a message of the one or more messages, where the request indicates that the message is to be in the second format. The message in the second format is returned from the converted messages storage to the consuming application.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment of a message manager in accordance with certain embodiments.

FIG. 3 illustrates further details of message repositories in accordance with certain embodiments.

FIG. 4 illustrates, in a flowchart, operations for collecting consumption data in accordance with certain embodiments.

FIG. 5 illustrates, in a flowchart, operations for setting a proactive conversion indicator in accordance with certain embodiments.

FIG. 6 illustrates, in a flowchart, operations for proactively converting messages in accordance with certain embodiments.

FIG. 7 illustrates, in a flowchart, operations for returning a proactively converted message in accordance with certain embodiments.

FIG. 8 illustrates, in a flowchart, operations for proactive message conversion by a message manager in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

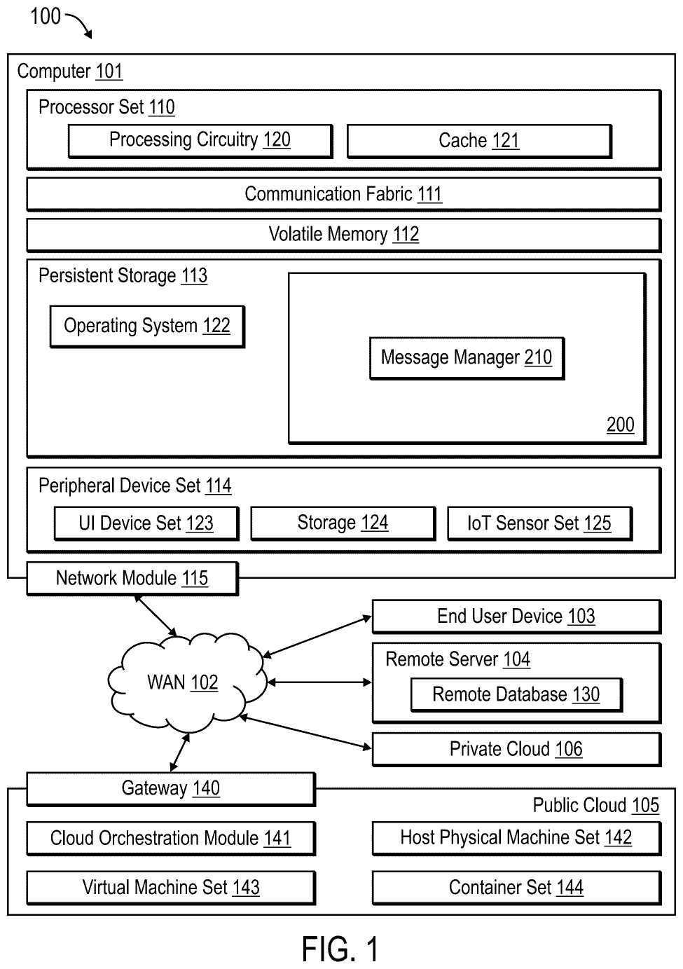

Computing environment 100 of FIG. 1 contains an example of an environment for the execution of at least some of the computer code involved in performing the inventive methods, such as a message manager 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

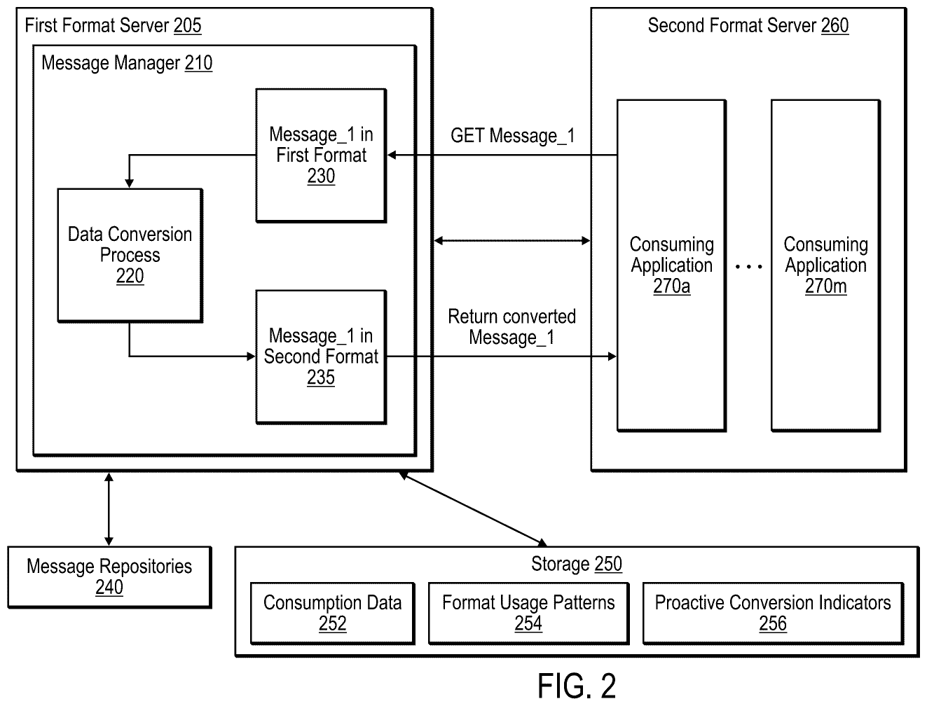

FIG. 2 illustrates a computing environment of a message manager 210 in accordance with certain embodiments. A first format server 205 is connected to a second format server 260. In certain embodiments, the first format server 205 has the components of computer 101. In certain embodiments, the second format server 205 has the components of computer 101 without the message manager 210.

A format may be described as a character encoding format. With embodiments, the first format server 205 and the second format server 260 use different character encoding formats. For example, the first format (i.e., an “original”, a “native” or a “source” format) of the first format server 205 may be Extended Binary Coded Decimal Interchange Code (EBCDIC), which is a data-encoding system that uses a unique eight-bit binary code for each number and alphabetic character as well as punctuation marks and accented letters and nonalphabetic characters. Continuing with the example, the second format (i.e., a “target” format) of the second format server 260 may be American Standard Code for Information Interchange (ASCII), which is a standard data-encoding format for electronic communication between computers. ASCII assigns standard numeric values to letters, numerals, punctuation marks, and other characters used in computers.

The first format server 205 includes a message manager 210 and is connected to message repositories 240 and to storage 250. The message manager 210 stores Message_1 in the first format 230 in a message repository of the message repositories 240. The storage 250 stores, for each consuming application 270a . . . 270m, consumption data 252, format usage patterns 254, and proactive conversion indicators 256. In certain embodiments, the message manager 210 identifies the format usage patterns 254 by analyzing the consumption data 252.

The message manager 210 includes a data conversion process 220. The data conversion process 220 proactively converts Message_1 in the first format 230 to Message_1 in the second format 235. In certain embodiments, the message manager 210 stores the converted Message_1 in the second format 235 in another repository of the message repositories 240.

The second format server 260 includes one or more consuming applications 270a . . . 270m (i.e., a message consumer). For example, the consuming application 270a requests (with a “GET” operation) Message_1 and indicates that Message_1 should be in the second format.

Then, the message manager 210 receives the request from the consuming application 270a for Message_1 in the second format. In response to this request, the message manager 210 returns the converted Message_1 in the second format 234 to the consuming application 270a.

In certain embodiments, the message manager 210 proactively (i.e., preemptively) converts a message (i.e., before the message conversion is requested) for increased throughput for the consuming applications 270a . . . 270m. In certain embodiments, converting the message may be described as converting message data (i.e., converting the data of that message).

In certain embodiments, the message manager 210 uses the consumption data 252 to identify the format usage patterns 254 for each consuming application 270a . . . 270m. The message manager 210 identifies the format usage patterns 254 by analyzing historical consumption of messages (i.e., the consumption data 252) in the message queue for each consuming application 270a . . . 270m. The format usage patterns 254 may also be referred to as a pattern of format requests. The consumption data 252 includes, for each consuming application 270a . . . 270m, which individual (i.e., different) formats have been requested (e.g., via GET operations) for messages and the frequency with which each of the individual formats has been requested (e.g., application ABC, format_x—10 times, format_y 15 times, etc.).

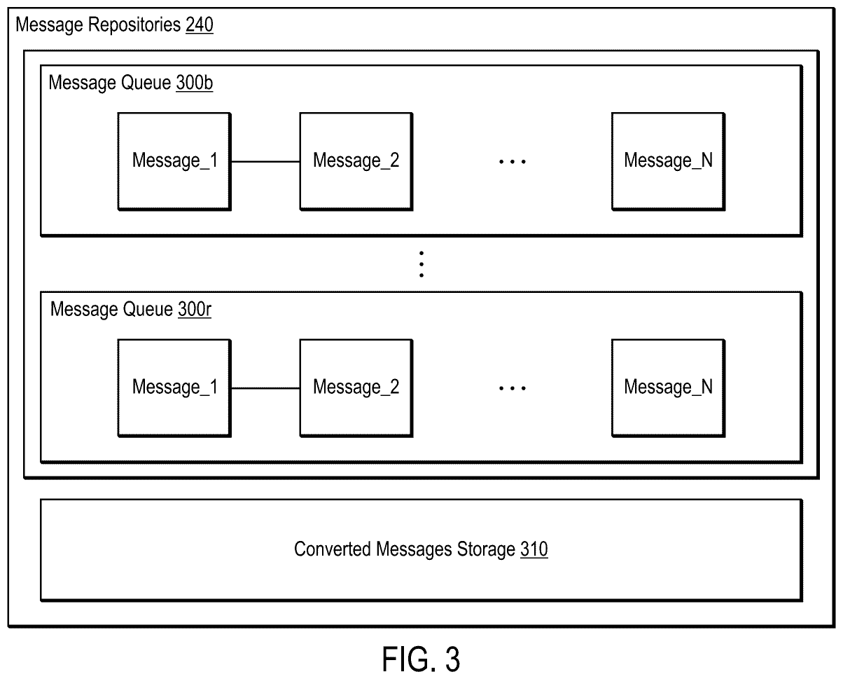

FIG. 3 illustrates further details of the message repositories 240 in accordance with certain embodiments. In certain embodiments, the message repositories 240 include a message queue for each consuming application. For example, the message repositories 240 include one or more message queues 300b . . . 300r. For example, message queue 300b has message_1, message_2, . . . message_N, and stores these messages in a first (“original”) format for a consuming application.

In addition, the message repositories 240 include converted messages storage 310. In certain embodiments, the converted messages are stored with a message identifier and a format identifier for easy retrieval. In certain embodiments, the converted messages are associated with the message queue and may be retrieved by any application. In certain embodiments, the message queue may store the converted messages with the messages in the original formats.

In certain embodiments, the message manager 210 proactively converts message_2 into a second format (i.e., not the first format that is used in the message queue 300). Then, if message_2 is requested in the second format, then the message manager 210 locates another version of message_2 in the converted messages storage 310 using a message identifier and the second format. In certain embodiments, message_2 may be proactively converted into multiple formats.

In certain embodiments, multiple applications consume from a single queue, and the application instances may have different requests for the second (“target”) format. In certain embodiments, the message manager 210 may perform the proactive conversion for the most common format requested across the multiple applications. In other embodiments, the message manager 210 may perform the proactive conversion for multiple formats on each message based on the format usage pattern 254 of the multiple applications.

In certain embodiments, the message manager 210 aims to reduce the amount of time spent performing message conversion at the time of message consumption by dynamically and proactively converting messages into one or more formats before a message has been requested by a consuming application. The message manager 210 makes the decision as to whether to proactively perform message conversion based on a number of factors, such as a format usage pattern 254 for that consumer application for a the message queue 300.

In order to facilitate this, the message manager 210 introduces a new data conversion process 220 in the message manager 210 that may interdependently be directed to look at original messages in the message queues and create duplicate messages in other formats (different from the format of the original message) that may be directly consumed by the consuming application. This avoids the message manager 210 having to convert the original message in response to receiving a request, from a consuming application, for the original message in another format.

This results in a better response time from the message manager 210 when the consuming application requests to consume a message in a different format than the format of the original message.

In certain embodiments, the message manager 210 proactively performs message conversion while the message is held on the message queue on a message host, before the consuming application request is made to consume that message. In certain embodiments, the message manager 210 proactively performs message conversion based on detecting that the consuming application is frequently performing message conversion. In certain embodiments, the conversion of a message is performed after a PUT operation is completed to store the message on the message queue and before a GET operation is received from a consuming application to remove the message from the message queue.

In certain embodiments, the message manager 210 implements a form of read ahead processing that uses the internal structure of a message queue to infer that certain other sections of the message may be desired in the future. The message manager 210 uses this knowledge to proactively fetch the other sections of the message into buffer pools.

With embodiments, the message manager 210 also proactively converts the message based on a determination that the consuming application is likely to request the message be converted to a second format (different from the first format of the message in the message queue). The data conversion process 220 implements a read ahead conversion task that proactively converts the message to the second format into a separate buffer (e.g., an example of the converted messages storage 310). If the next application consumer requests the message in the second format, then the message manager 210 returns the converted message returned directly to the consuming application from the separate buffer, which allows conversion to be bypassed at the point in time that the consuming application is to consume the message.

In certain embodiments, while consuming applications are consuming messages from a message queue, the message manager 210 keeps track of the format (e.g., character encodings or Coded Character Set Identifiers (CCSIDs)) that the consuming applications are requesting for messages. In certain embodiments, the message manager 210 determines from some heuristic that a large proportion of the messages are being converted to the same format, then the message manager 210 starts proactively converting subsequent messages on the message queue to that same format. The message manager 210 may use the data conversion process 220 to perform the conversion or may issue a request for conversion that is offloaded to a helper task that would convert the message into separate buffers.

When the consuming application subsequently requests a message from the message queue specifying conversion to the same format, the message manager 210 returns the converted message from the buffers. This allows the consuming application to skip the potentially time-consuming conversion process. The net result of this, assuming the helper task is able to keep up with the consuming applications, is that the throughput is increased for the consuming applications.

In some instances, there are “conversion misses”. That is, the tradeoff for the increased throughput is that if the message was requested specifying conversion to a different format or with no conversion, then the cost of converting the message is a “conversion miss”. In certain embodiments, the heuristic used to decide whether to perform the conversion takes these “conversion misses” into account.

The message manager 210 uses a heuristic that monitors the consumption behavior of connected consuming applications. In addition, the message manager 210 facilitates the proactive conversion of a message before a message has been requested to be consumed. Moreover, the message manager 210 is connected to a new storage area that holds the proactively converted messages for easy retrieval.

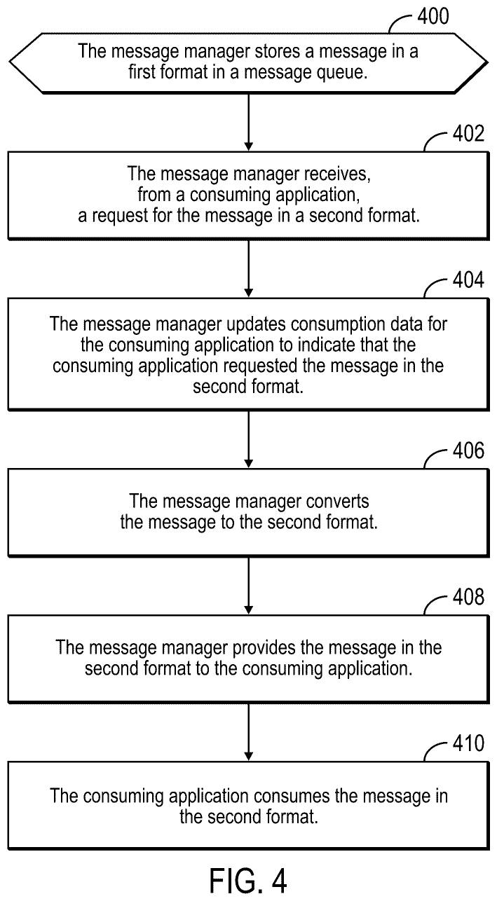

FIG. 4 illustrates, in a flowchart, operations for collecting consumption data 252 in accordance with certain embodiments. Control begins at block 400 with the message manager 210 storing a message in a first format in a message queue. In block 402, the message manager 210 receives, from a consuming application, a request for the message in a second format. In block 404, the message manager 210 updates consumption data 252 for the consuming application to indicate that the consuming application requested the message in the second format. In block 406, the message manager 210 converts the message to the second format. In block 408, the message manager 210 provides the message in the second format to the consuming application. In block 410, the consuming application consumes (i.e., processes) the message in the second format.

That is, during a consumption data collection (“first”) phase, the message manager 210 may convert the message to the second format after receiving a request for the message in the second format. In other embodiments, a proactive conversion indicator 256 is set (e.g., by a user, such as a system administrator), and the message manager 210 proactively converts messages without need for this data collection phase.

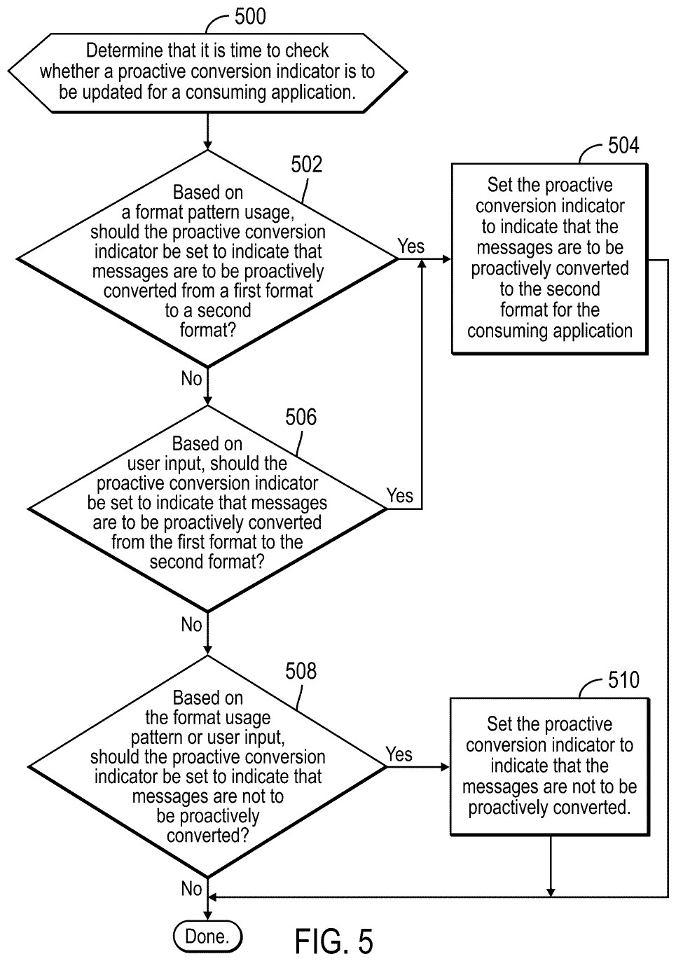

FIG. 5 illustrates, in a flowchart, operations for setting a proactive conversion indicator 256 in accordance with certain embodiments. Control begins at block 500 with the message manager 210 determining that it is time to check whether a proactive conversion indicator is to be updated for a consuming application. In certain embodiments, the message manager 210 periodically determines that it is time to check whether a proactive conversion indicator is to be updated for a consuming application. In certain embodiments, the proactive conversion indicator 256 has a first value (e.g., 0) to indicated that messages are not to be proactively converted and a second value (e.g., 1) to indicate that messages are to be proactively converted to a particular format for the consuming application. In certain embodiments, the operations of FIG. 5 are performed for each of the consuming applications.

In block 502, based on the format usage pattern 254 for the consuming application, the message manager 210 determines whether the proactive conversion indicator 256 should be set to indicate that messages are to be proactively converted from a first format to a second format. If so, processing continues to block 504, otherwise, processing continues to block 506.

In block 504, the message manager 210 sets the proactive conversion indicator 256 to indicate that the messages are to be proactively converted from the first format to the second format for the consuming application.

In block 506, based on user input, the message manager 210 determines whether the proactive conversion indicator 256 should be set to indicate that messages are to be proactively converted from the first format to the second format. If so, processing continues to block 504, otherwise, processing continues to block 508.

In block 508, based on the format usage pattern 254 or user input, the message manager 210 determines whether the proactive conversion indicator 256 should be set to indicate that messages are not to be proactively converted. If so, processing continues to block 510, otherwise, processing continues to block 500.

In block 510, the message manager 210 sets the proactive conversion indicator 256 to indicate that the messages are not to be proactively converted.

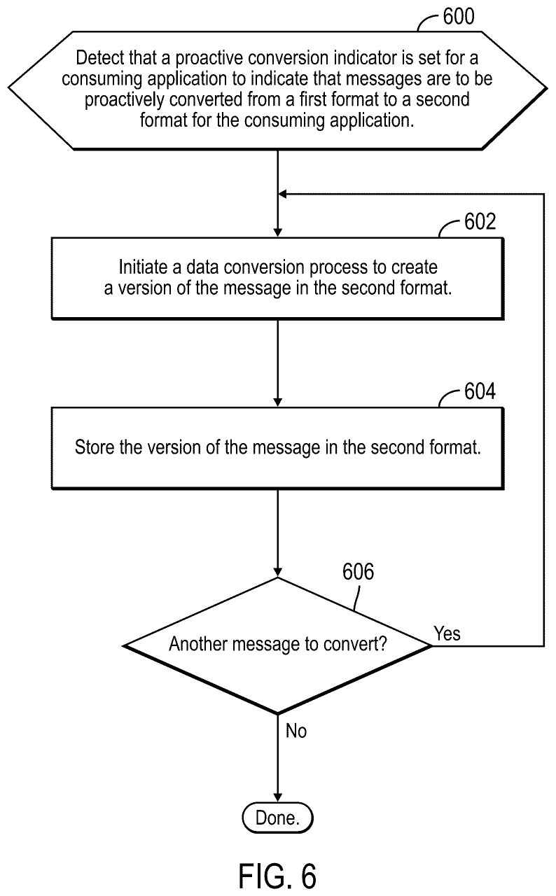

FIG. 6 illustrates, in a flowchart, operations for proactively converting messages in accordance with certain embodiments. Control begins at block 600 with the message manager 210 detecting that a proactive conversion indicator 256 is set for a consuming application to indicate that messages are to be proactively converted from a first format to a second format for the consuming application (i.e., as the consuming application is likely to request messages in the second format). In block 602, the message manager 210 initiates the data conversion process 220 to create a version of the message in the second format. In block 604, the message manager 210 stores the version of the message in the second format. In block 606, the message manager 210 determines whether there is another message to convert. If so, processing continues to block 600, otherwise, processing is done.

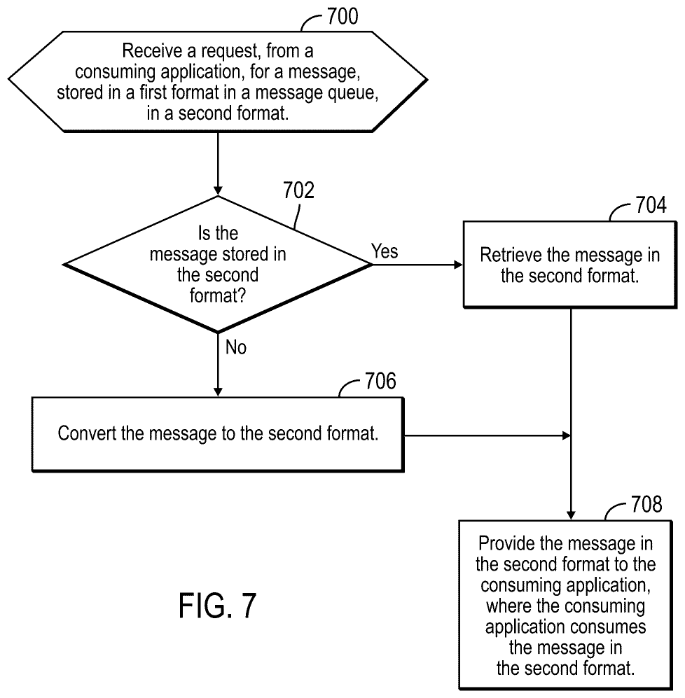

FIG. 7 illustrates, in a flowchart, operations for returning a proactively converted message in accordance with certain embodiments. Control begins at block 700 with the message manager 210 receiving a request, from a consuming application, for a message, stored in a first format in a message queue, in a second format. That is, the consuming application requests the message in the second format.

In block 702, the message manager 210 determines whether the message is stored in the second format. If so, processing continues to block 704, otherwise, processing continues to block 706. In block 704, the message manager 210 retrieves the message in the second format and processing continues to block 708. In block 706, the message manager 210 converts the message to the second format and processing continues to block 708. In block 708, the message manager 210 provides the message in the second format to the consuming application, where the consuming application consumes the message in the second format.

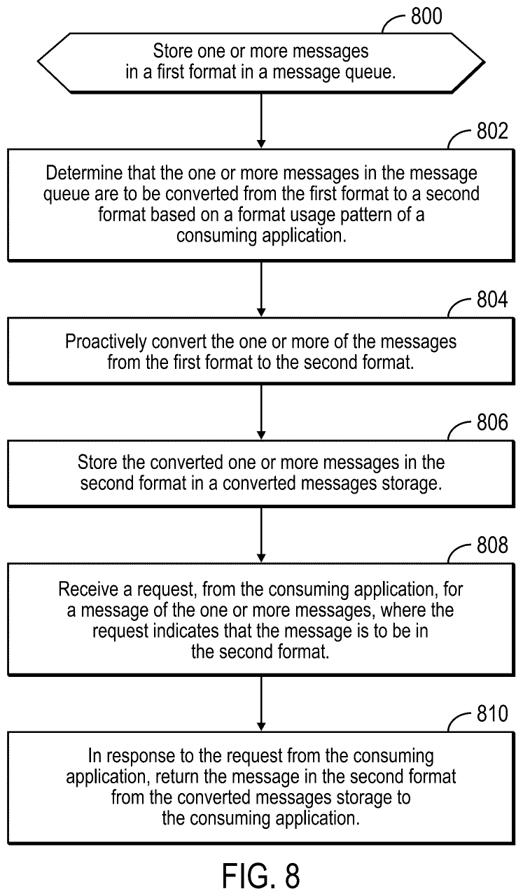

FIG. 8 illustrates, in a flowchart, operations for proactive message conversion by a message manager in accordance with certain embodiments. Control begins at block 800 with the message manager 210 storing one or more messages in a first format in a message queue.

In block 802, the message manager 210 determines that the one or more messages in the message queue are to be converted from the first format to a second format based on a format usage pattern 254 (i.e., a pattern of format requests) of a consuming application. In certain embodiments, the message manager 210 collects consumption data 252 for a consuming application and analyzes the consumption data 254 to identify the format usage pattern 254. In certain embodiments, the determination that the one or more messages in the message queue are to be converted is based on checking that the proactive conversion indicator 256 is set to indicate that the one or more messages in the message queue are to be converted from the first format to the second format. In certain embodiments, the message manager 210 sets the proactive conversion indicator 256 based on one of the format usage pattern 254 and user input.

In block 804, the message manager 210 proactively converts the one or more of the messages from the first format to the second format. In certain embodiments, the message manager 210 proactively converts the one or more of the messages from the first format to multiple formats (e.g., to the second format, to a third format, etc.).

In block 806, the message manager 210 stores the converted one or more messages in the second format in the converted messages storage 310. In certain embodiments, each of the converted one or more messages is stored with a message identifier and a format identifier.

In block 808, the message manager 210 receives a request, from the consuming application, for a message of the one or more messages, where the request indicates that the message is to be in the second format.

In block 810, in response to the request from the consuming application, the message manager 210 returns the message in the second format from the converted messages storage 310 to the consuming application. In particular, the message manager 210 retrieves the message in the second format from the converted messages storage 310 and returns that message to the consuming application.

In certain embodiments if it is determined that a consuming application is likely to want to get one or more messages (stored in a message queue in a first format) that will have to be converted (to a second format), the message manager 210 proactively converts the one or more messages to the second format and stores the one or more converted messages in the second format. When the consuming application later requests a message in the second format, the message manager 210 checks whether that message has been proactively converted to the second format and stored. If so, the message manager 210 returns the converted message in the second format, saving conversion time.

In certain embodiments, the consuming application requests a message from a message queue in a different format from the format the message is stored in. The message manager 210 provides a proactively converted message to the consuming application, and the consuming application finishes consuming the message.

In certain embodiments, the message manager 210 detects that the consuming application is likely to request a message in a new format. The message manager tells the data conversion process 220 to proactively create (i.e., by conversion) and store a version of the message in the new format. The consuming application requests a message from a message queue in the new format, where the message is stored in the message queue in an original format. The message manager 210 checks for the message in the new format. If the message in the new format is available, the message manager 210 returns the message in the new format.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product, the computer program product comprising a computer readable storage medium having program instructions embodied therewith, the program instructions executable by a computer processor to cause the computer processor to perform operations comprising:
storing one or more messages in a first format in a message queue;
determining that the one or more messages in the message queue are to be converted from the first format to a second format based on a format usage pattern of a consuming application;
proactively converting the one or more of the messages from the first format to the second format;
storing the proactively converted one or more messages in the second format in a converted messages storage;
receiving a request, from the consuming application, for a message of the one or more messages, wherein the request indicates that the message is to be in the second format; and
returning the message in the second format from the converted messages storage to the consuming application.

2. The computer program product of claim 1, wherein the program instructions are executable by the computer processor to cause the computer processor to perform further operations comprising:
collecting consumption data for the consuming application; and
identifying the format usage pattern based on the consumption data.

3. The computer program product of claim 1, wherein the program instructions for determining that the one or more messages in the message queue are to be converted are executable by the computer processor to cause the computer processor to perform further operations comprising:
checking that a proactive conversion indicator is set to indicate that the one or more messages in the message queue are to be converted from the first format to the second format.

4. The computer program product of claim 3, wherein the program instructions are executable by the computer processor to cause the computer processor to perform further operations comprising:
setting the proactive conversion indicator based on one of the format usage pattern and user input.

5. The computer program product of claim 1, wherein the one or more messages are proactively converted into multiple formats.

6. The computer program product of claim 1, wherein each of the proactively converted one or more messages is stored with a message identifier and a format identifier.

7. The computer program product of claim 1, wherein the program instructions are executable by the computer processor to cause the computer processor to perform further operations comprising:
receiving a new request, from the consuming application, for a new message of the one or more messages, wherein the new request indicates that the new message is to be in the second format;
determining that the new message is not stored in the second format in the converted messages storage;
converting the new message from the first format to the second format; and
returning the new message in the second format to the consuming application.

8. A computer system, comprising:
one or more computer processors, one or more computer-readable memories and one or more computer-readable, tangible storage devices; and
program instructions, stored on at least one of the one or more computer-readable, tangible storage devices for execution by at least one of the one or more computer processors via at least one of the one or more computer-readable memories, to perform operations comprising:
storing one or more messages in a first format in a message queue;
determining that the one or more messages in the message queue are to be converted from the first format to a second format based on a format usage pattern of a consuming application;
proactively converting the one or more of the messages from the first format to the second format;
storing the proactively converted one or more messages in the second format in a converted messages storage;
receiving a request, from the consuming application, for a message of the one or more messages, wherein the request indicates that the message is to be in the second format; and
returning the message in the second format from the converted messages storage to the consuming application.

9. The computer system of claim 8, wherein the operations further comprise:
collecting consumption data for the consuming application; and
identifying the format usage pattern based on the consumption data.

10. The computer system of claim 8, wherein the operations for determining that the one or more messages in the message queue are to be converted further comprise:
checking that a proactive conversion indicator is set to indicate that the one or more messages in the message queue are to be converted from the first format to the second format.

11. The computer system of claim 10, wherein the operations further comprise:
setting the proactive conversion indicator based on one of the format usage pattern and user input.

12. The computer system of claim 8, wherein the one or more messages are proactively converted into multiple formats.

13. The computer system of claim 8, wherein each of the proactively converted one or more messages is stored with a message identifier and a format identifier.

14. The computer system of claim 8, wherein the operations further comprise:
receiving a new request, from the consuming application, for a new message of the one or more messages, wherein the new request indicates that the new message is to be in the second format;
determining that the new message is not stored in the second format in the converted messages storage;
converting the new message from the first format to the second format; and
returning the new message in the second format to the consuming application.

15. A computer-implemented method, comprising operations for:
storing one or more messages in a first format in a message queue;
determining that the one or more messages in the message queue are to be converted from the first format to a second format based on a format usage pattern of a consuming application;
proactively converting the one or more of the messages from the first format to the second format;
storing the proactively converted one or more messages in the second format in a converted messages storage;
receiving a request, from the consuming application, for a message of the one or more messages, wherein the request indicates that the message is to be in the second format; and
returning the message in the second format from the converted messages storage to the consuming application.

16. The computer-implemented method of claim 15, further comprising operations for:
collecting consumption data for the consuming application; and
identifying the format usage pattern based on the consumption data.

17. The computer-implemented method of claim 15, wherein the operations for determining that the one or more messages in the message queue are to be converted further comprise operations for:
checking that a proactive conversion indicator is set to indicate that the one or more messages in the message queue are to be converted from the first format to the second format.

18. The computer-implemented method of claim 17, further comprising operations for:
setting the proactive conversion indicator based on one of the format usage pattern and user input.

19. The computer-implemented method of claim 15, wherein the one or more messages are proactively converted into multiple formats.

20. The computer-implemented method of claim 15, wherein each of the proactively converted one or more messages is stored with a message identifier and a format identifier.
